(19) United States
(12) Patent Application Publication
(10) Pub. No.: US 2007/0165576 A1
(43) Pub. Date: Jul. 19, 2007

(54) MIMO CONTROL CHANNEL WITH SHARED CHANNELIZATION CODES

(75) Inventors: Yi-Pin Eric Wang, Cary, NC (US); Jung-Fu Cheng, Cary, NC (US); Stephen Grant, Cary, NC (US); Leonid Krasny, Cary, NC (US); Karl James Molnar, Cary, NC (US)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/275,388

(22) Filed: Dec. 29, 2005

(51) Int. Cl. H04B 7/216

(52) U.S. Cl. 370/335; 370/342

(57) ABSTRACT

A control channel for MIMO users operating in conjunction with an HS-DSCH system shares channelization codes with an HS-SCCH control channel. MIMO control channel information can be signaled from a transmit antenna selected based on information produced by the intended recipient. The modulation format used by a MIMO control channel can be selected based on the number of antenna streams in the corresponding MIMO data transmission.

### FIELD OF THE INVENTION

The invention relates generally to wireless communication and, more particularly, to control channels in wireless communication.

### BACKGROUND OF THE INVENTION

The following documents are incorporated herein by reference:
[1] S. T. Chung, A. Lozano, and H. Huang, “Approaching eigenmode BLAST channel capacity using V-BLAST with rate and power feedback”, IEEE Veh. Technol. Conf., pp. 915-919, September 2001.
[2] S. Grant, J.-F. Cheng, L. Krasny, K. Molnar, and Y.-P. E. Wang, “Per-antenna rate control (PARC) in frequency selective fading with SIC-GRAKE Receiver”, IEEE Veh. Technol. Conf., September 2004.
[3] H. Zheng, A. Lozano, and H. Huang, “Multiple ARQ processes for MIMO systems”, Proc. IEEE Personal, Indoor and Mobile Commun., pp. 1023-1026, Sep. 15-18, 2002.
[4] U.S. patent application Ser. No. 10/841,911, filed on May 7, 2004, entitled “Base station, mobile terminal device and method for implementing a selective-per-antenna rate-control (S-PARC) technique in a wireless communications network”.

Multiple-input-multiple output (MIMO) technologies have been considered for enhancing data rates in third generation cellular systems such as the High-Speed Downlink Shared Channel (HS-DSCH) provision of the WCDMA standard. Recently, a MIMO technique referred to as Per-Antenna-Rate-Control (PARC) has been proposed for use with HS-DSCH (see document [1] above). The PARC scheme is based on a combined transmit/receive architecture that performs independent coding of the antenna streams at different rates, and applies successive interference cancellation (SIC) and decoding at the receiver. Selective PARC (S-PARC) is an extension of PARC that includes antenna selection (see document [2] above). With S-PARC, a physical layer transport format includes selected antennas, decoding order, channelization code assignment, modulation format(s), and coding rate(s).

In WCDMA (Wideband CDMA) release 5, a downlink control channel referred to as the High-Speed Shared Control Channel (HS-SCCH) is used to signal which user is scheduled to receive a HS-DSCH transmission in the associated transmission time interval (TTI). The HS-SCCH also signals transport format information and HARQ (Hybrid-ARQ) information for the associated TTI. FIG. 1 illustrates the timing relationship between HS-SCCH and HS-DSCH. As shown, each HS-DSCH subframe is transmitted two time slots later than its associated HS-SCCH subframe. The addressed user equipment (e.g., a mobile terminal) thus receives all of part I on HS-SCCH before it receives the associated data on HS-DSCH. Part I signals a user equipment identifier, together with sufficient information (e.g., channelization code allocation and modulation format) to permit the addressed user equipment to configure its RAKE receiver. The two-time slot offset allows the user equipment enough processing time to complete the RAKE receiver configuration before the data arrives on HS-DSCH. Part II of the HS-SCCH subframe carries coding information and HARQ related information that are needed to process the RAKE outputs and recover the information bits that have been transmitted on HS-DSCH. Also, WCDMA release 5 provides for up to four HS-SCCHs to signal up to four different users in a given TTI. Each HS-SCCH is assigned a channelization code of spreading factor 128. According to WCDMA release 5, HS-DSCH is always configured for one data stream (non-MIMO). Thus, HS-SCCH according to WCDMA release 5 is only used to signal to users operating in the non-MIMO mode.

In order to use MIMO technologies effectively with HS-DSCH, there is a need to transmit to the user equipment MIMO-related control information of the same general type described above with respect to HS-SCCH.

### SUMMARY OF THE INVENTION

Exemplary embodiments of the invention provide a control channel for MIMO users operating in conjunction with an HS-DSCH system. These exemplary embodiments can allocate a fixed radio resource, e.g., power and available channelization codes, for a data transmission to either a MIMO user or a non-MIMO user in a transmission time interval. To support such a data transmission, a control signal is sent prior to the data transmission to provide information such as the user equipment identifier for which the associated data transmission is intended, transport format, and HARQ-related information. When a non-MIMO user is intended, a non-MIMO control channel is transmitted, whereas when a MIMO user is intended, a MIMO control channel is transmitted. The MIMO control channel shares a channelization code with the non-MIMO control channel. That is, a channelization code is used to transmit either the non-MIMO control channel or the MIMO control channel, depending on whether the fixed radio resource is used to provide data transmission to a non-MIMO user or a MIMO user. In some embodiments, MIMO control channel information can be signaled from a transmit antenna selected based on information produced by the intended recipient. In some embodiments, the modulation format used by a MIMO control channel can be selected based on the number of antenna streams in the corresponding MIMO data transmission.

### BRIEF DESCRIPTION OF THE DRAWINGS

FIG. 1 is a timing diagram that shows the timing relationship between an HS-SCCH control channel and an HS-SDCH data channel in conventional WCDMA systems.

FIG. 2 diagrammatically illustrates a CDMA transmitter apparatus according to exemplary embodiments of the invention.

FIG. 3 diagrammatically illustrates HS-SCCH coding and modulation according to the prior art.

FIG. 4 diagrammatically illustrates a CDMA transmitter apparatus according to further exemplary embodiments of the invention.

### DETAILED DESCRIPTION

Exemplary embodiments of the invention provide a control channel for signaling control information such as user equipment identifiers, channelization code allocation, transport formats, including number of MIMO data streams, modulations, and transport block sizes or coding rates, and HARQ-related information, to MIMO users operating in conjunction with an HS-DSCH system. This control channel is referred to generally herein as MIMO-SCCH, and the associated data transmission channel is referred to generally herein as MIMO-DSCH. The MIMO-SCCH control channel shares channelization codes with the HS-SCCH control channel. Thus, no additional channelization codes are needed for MIMO-SCCH. The MIMO-SCCH control channel can be signaled from the best available transmit antenna, as indicated by the channel quality report of the intended recipient. The modulation format used by the MIMO-SCCH control channel can be adjusted based on the number of antenna streams that will be used for the corresponding MIMO data transmission.

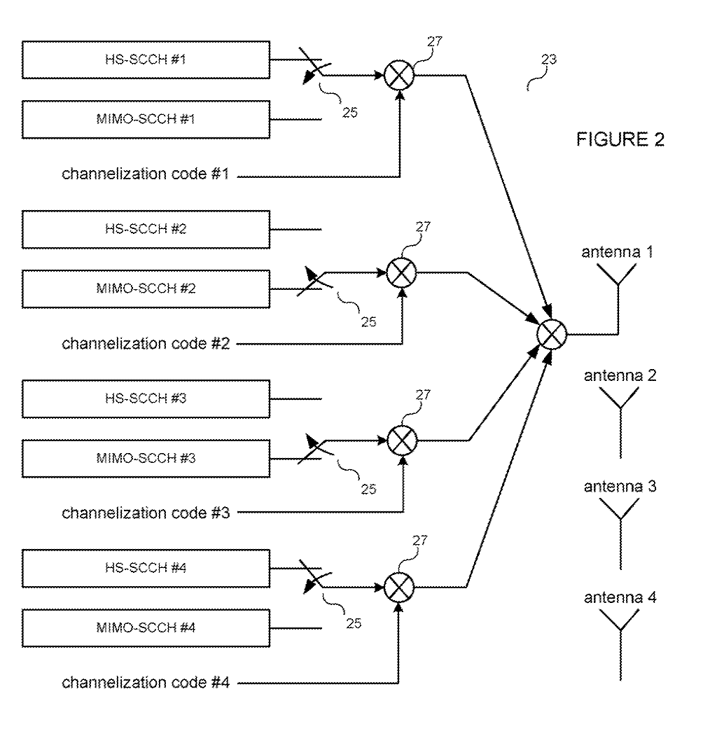

FIG. 2 diagrammatically illustrates exemplary embodiments of a WCDMA transmitter apparatus according to the invention. In some embodiments, the transmitter apparatus of FIG. 2 is provided at a fixed-site base station. The transmitter includes a transmission controller 23 arranged so that each of the four illustrated MIMO-SCCH control channels shares one of the four illustrated channelization codes with a respectively corresponding one of the four illustrated HS-SCCH control channels. The transmission controller 23 includes four selectors 25, each of which can selectively receive either a corresponding MIMO-SCCH control information input, or a corresponding HS-SCCH control information input, depending on whether the associated data transmission is intended for a MIMO user or a non-MIMO user. As shown generally at 27, the transmission controller 23 applies respective channelization codes to the control information inputs selected by the respective selectors 25.

The transmission controller 23 controls the selectors 25 such that each channelization code can be selectively applied either to the corresponding MIMO-SCCH control information or to the corresponding HS-SCCH control information. More specifically, each channelization code n, as contained in the group defined by n=1, 2, 3 and 4, can be applied either to the control information that has been provided for transmission on control channel MIMO-SCCH n or to the control information that has been provided for transmission on control channel HS-SCCH n. In this manner, any single channelization code can be used to signal control channel information to either an HS-DSCH user or a MIMO-DSCH user, and no added codes are needed to implement MIMO-SCCH. A given receiver terminal (user equipment) listens to HS-SCCH or MIMO-SCCH, depending on whether it is operating in HS-DSCH reception mode or in MIMO reception mode.

In systems such as the aforementioned PARC system, different transmit antennas can use different transport formats. Therefore, a MIMO-SCCH control channel may need to signal more than one transport format to set up a data transmission via more than one antenna. On the other hand, HS-SCCH only needs to signal a single transport format because it is setting up an HS-DSCH data transmission that uses only a single antenna. Therefore, MIMO-SCCH may at times need to signal more information than does HS-SCCH. But, because MIMO-SCCH is to use the same channelization code as HS-SCCH, this implies that, for both channels, the channelization code will be applied to the same number of encoded bits if both channels use QPSK modulation. Therefore, when MIMO-SCCH uses more information bits than HS-SCCH, the coding rate for the MIMO-SCCH channel will be higher than the coding rate for the HS-SCCH channel.

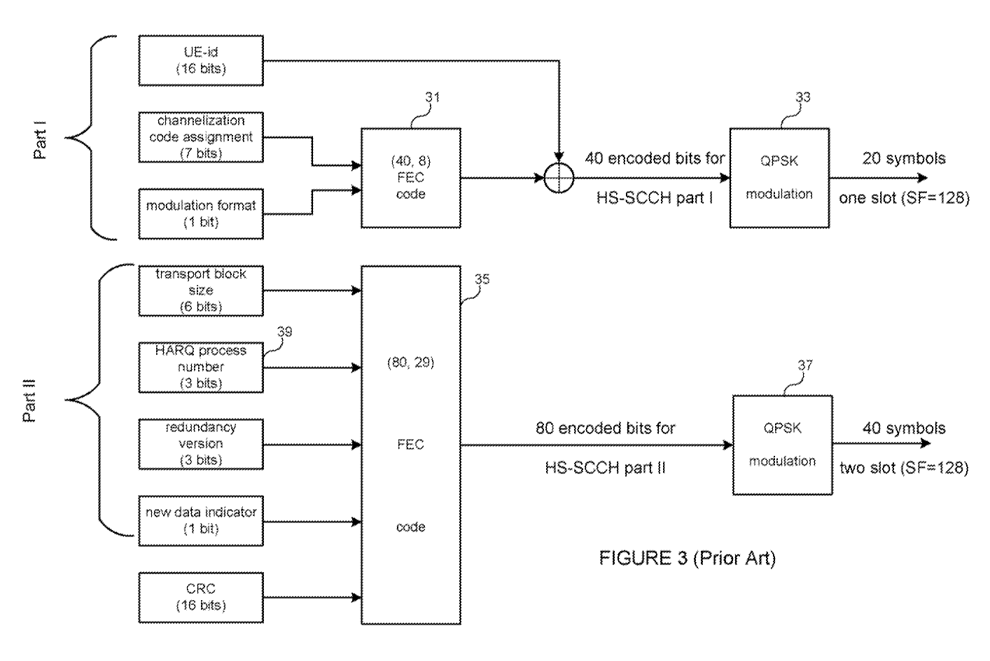

The coding scheme of HS-SCCH is illustrated in FIG. 3. At 31, Part I information is encoded into 40 bits. At 33, the 40 encoded bits are mapped to 20 QPSK symbols in a slot, using a spreading factor of 128. At 35, Part II information is encoded (together with the CRC information) into 80 bits. At 37, the 80 encoded bits are mapped to 40 QPSK in a slot. Thus, in order to re-use the same channelization code as HS-SCCH, MIMO-SCCH is limited to 20 symbols for Part I information, and 40 symbols for Part II information.

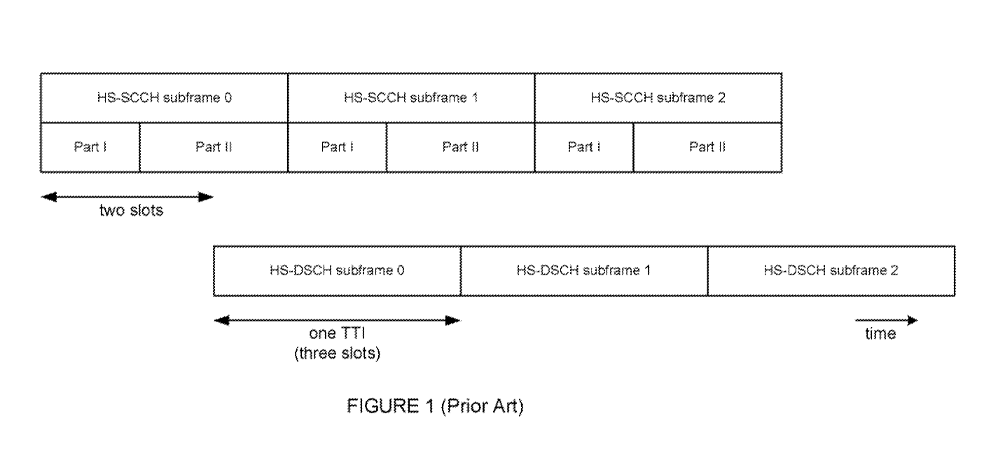

A per-stream HARQ scheme for MIMO technology has also been proposed (see document [3] above), and has been shown to provide better throughput than per-TTI HARQ. However, in order to support per-stream HARQ processing, all of the information in Part II (see FIGS. 1 and 3) must be provided for each antenna stream. Taking a 4×4 MIMO system as an example, and referring to FIG. 3, a complete set of Part II information bits will contain (6+3+3+1)×4=52 bits. These 52 bits, plus the 16 CRC bits, would then need to be encoded. Also, the number of bits needed for identifying each HARQ process (see 39 in FIG. 3) may need to be increased because, with per-stream HARO, the number of unacknowledged HARQ processes at any given time is increased.

For reasons such as those given above and others, it can be seen that, in many instances, if a MIMO-SCCH channel is constrained by the encoded bit limitations imposed by HS-SCCH (40 bits for Part I and 80 bits for Part II), then the coding gain can be significantly compromised. Some exemplary embodiments of the invention use higher order modulation to help alleviate the aforementioned coding gain problem. For example, some embodiments use higher order modulation when the number of antenna streams exceeds a threshold. Various exemplary embodiments use 16-QAM instead QPSK to modulate the encoded Part II bits when the number of antenna streams is at least 3 or 4. With 16-QAM modulation, the number of available encoded bits for Part II is 160, i.e., the coding can be adjusted in correspondence to the modulation adjustment, as is well known in the art. Accordingly, the FEC coding gain can be substantially improved by using the higher order modulation.

However, a higher order modulation can generally be expected to be less energy efficient than a lower order modulation. Some exemplary embodiments attempt to compensate for this by using the best available transmit antenna for the MIMO-SCCH signaling. In some embodiments, available channel quality reports received from the user equipment are inspected to determine which antenna is best for transmission to that user. Note that, typically, with a relatively high number of antenna streams, the user terminal will correspondingly enjoy a relatively high signal-to-interference-plus-noise ratio (SNIR). In such scenarios, the best transmit antenna will often deliver high enough capacity to justify the use of the higher order modulation.

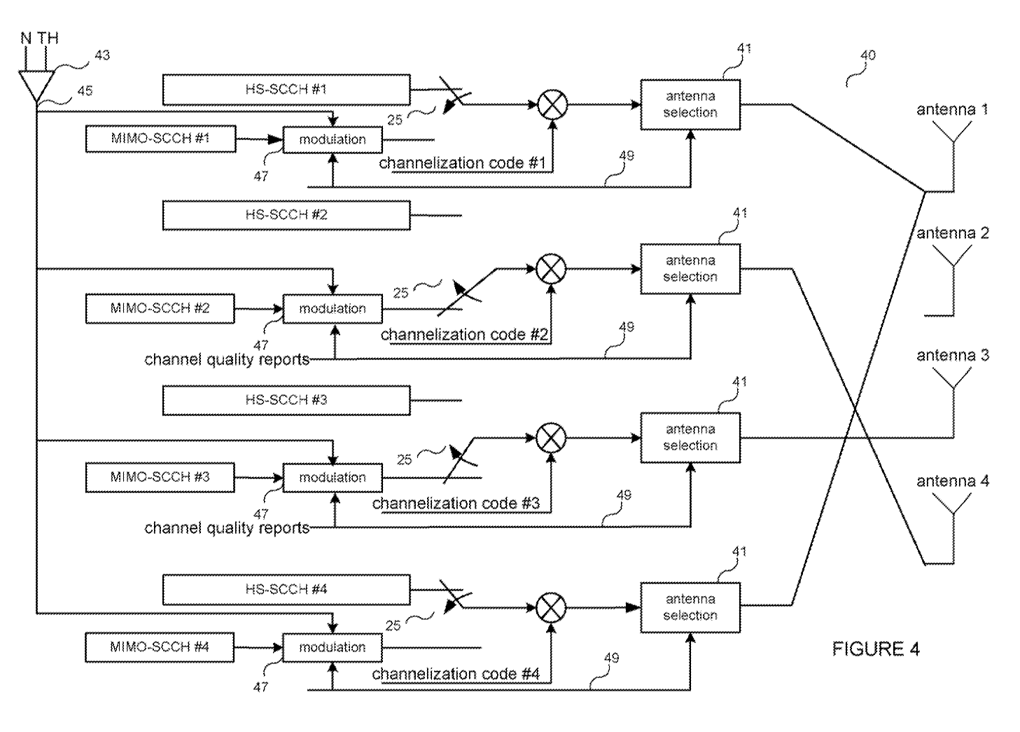

FIG. 4 diagrammatically illustrates further exemplary embodiments of a WCDMA transmitter apparatus according to the invention. The transmitter structure of FIG. 4 is generally similar to that of FIG. 2, but the transmission controller 40 of FIG. 4 additionally incorporates best transmit antenna selection and higher order modulation selection such as described above. In the exemplary configuration shown in FIG. 4, channelization codes 1 and 4 are used to signal HS-SCCH, and channelization codes 2 and 3 are used to signal MIMO-SCCH. The channels HS-SCCH1 and HS-SCCH4 are both signaled from antenna 1 (this preserves backward compatibility to non-MIMO systems). The channels MIMO-SCCH2 and MIMO-SCCH3 are respectively signaled from antennas 4 and 3. The antennas for transmission of channels MIMO-SCCH2 and MIMO-SCCH3 are determined by antenna selectors 41 based on the channel quality reports 49 provided by the respectively scheduled users. A comparator 43 compares the number N of MIMO streams to a threshold value TH, and outputs a control signal 45 which signals transport formatters 47 to use a higher order modulation (e.g., 16-QAM) if the number of streams meets the threshold, and which otherwise signals the transport formatters 47 to use the usual HS-SCCH modulation (e.g., QPSK). Recalling also that, with PARC, different antennas can use different transport formats, the users' channel quality reports are also provided to the transport formatters 47, so that the transport formatters 47 can appropriately match the transport formatting to the selected antenna.

In some embodiments, MIMO-SCCH is designed to achieve a low imitation probability, that is, a tolerably low probability that a MIMO-SCCH message will be received as HS-SCCH. This is achieved in such embodiments by, for example, applying to the encoded Part I, Part II, and CRC bits a scrambling mask that is specifically associated with the scheduled user. Similar masking is known and used in prior art HS-SCCH systems.

Although exemplary embodiments of the invention have been described above in detail, this does not limit the scope of the invention, which can be practiced in a variety of embodiments.

What is claimed:

1. A CDMA transmitter apparatus, comprising:
an input for providing first control information to be transmitted on a first control channel used to provide parameters for an associated MIMO CDMA data transmission; and
a transmission controller coupled to said input and capable of applying to said first control information a channelization code that is also available to be applied to second control information transmitted on a second control channel used to provide parameters for an associated single-antenna CDMA data transmission.

2. The apparatus of claim 1, wherein said transmission controller is responsive to information produced by an intended recipient of said first control information for selecting one of a plurality of available antennas to transmit said first control information on said first control channel.

3. The apparatus of claim 2, wherein said transmission controller selects a modulation format for said first control channel based on a number of antenna streams to be contained in the associated MIMO CDMA data transmission.

4. The apparatus of claim 1, wherein said transmission controller selects a modulation format for said first control channel based on a number of antenna streams to be contained in the associated MIMO CDMA data transmission.

5. The apparatus of claim 1, wherein said first control information includes a receiver identity.

6. The apparatus of claim 1, wherein said first control information includes a transport format to be used for the MIMO data transmission.

7. The apparatus of claim 6, wherein said transport format includes a number of antenna streams to be contained in the MIMO data transmission.

8. The apparatus of claim 6, wherein said transport format includes a modulation order to be used for the MIMO data transmission.

9. The apparatus of claim 6, wherein said transport format includes a transport block size to be used for the MIMO data transmission.

10. The apparatus of claim 6, wherein said transport format includes a coding rate to be used for the MIMO data transmission.

11. The apparatus of claim 1, wherein the MIMIO data transmission utilizes a plurality of code-division multiplexed channels, and said first control information includes channelization code information.

12. A wireless transmitter apparatus, comprising:
an input that provides information produced by an intended recipient of a MIMO data transmission; and
a transmission controller coupled to said input and responsive to said information for selecting one of a plurality of available antennas to transmit control information on a control channel used to provide parameters for the MIMO data transmission.

13. The apparatus of claim 12, wherein said information produced by the intended recipient includes information indicative of communication quality associated with one of said antennas.

14. The apparatus of claim 12, wherein the intended recipient is a CDMA receiver apparatus.

15. The apparatus of claim 12, wherein said transmission controller selects a modulation format for said control channel based on a number of antenna streams to be contained in the associated MIMO data transmission.

16. The apparatus of claim 12, wherein said information produced by the intended recipient includes a signal-to-interference-plus-noise ratio associated with one of said antennas.

17. The apparatus of claim 12, wherein said control information includes a receiver identity.

18. A wireless transmitter apparatus, comprising:
an input that provides information indicative of a number of antenna streams to be contained in a MIMO data transmission; and
a transmission controller coupled to said input and responsive to said information for selecting a modulation format for transmission of control information on a control channel used to provide parameters for the MIMO data transmission.

19. The apparatus of claim 18, wherein the MIMO data transmission associated with said control channel uses per-antenna stream HARQ.

20. The apparatus of claim 18, wherein a modulation order of the modulation format selected by said transmission controller increases in response to an increase in said number of antenna streams and decreases in response to a decrease in said number of antenna streams.

21. A method for CDMA transmission, comprising:
providing first control information to be transmitted on a first control channel used to provide parameters for an associated MIMO CDMA data transmission; and
applying to said first control information a channelization code that is also available to be applied to second control information transmitted on a second control channel used to provide parameters for an associated single-antenna CDMA data transmission.

22. The method of claim 21, including, based on information produced by an intended recipient of said first control information, selecting one of a plurality of available antennas to transmit said first control information on said first control channel.

23. The method of claim 22, including selecting a modulation format for said first control channel based on a number of antenna streams to be contained in the associated MIMO CDMA data transmission.

24. The method of claim 21, including selecting a modulation format for said first control channel based on a number of antenna streams to be contained in the associated MIMO CDMA data transmission.

25. The method of claim 21, wherein said first control information includes a receiver identity.

26. The method of claim 21, wherein said first control information includes a transport format to be used for the MIMO data transmission.

27. The method of claim 26, wherein said transport format includes a number of antenna streams to be contained in the MIMO data transmission.

28. The method of claim 26, wherein said transport format includes a modulation order to be used for the MIMO data transmission.

29. The method of claim 26, wherein said transport format includes a transport block size to be used for the MIMO data transmission.

30. The method of claim 26, wherein said transport format includes a coding rate to be used for the MIMO data transmission.

31. The method of claim 21, wherein the MIMIO data transmission utilizes a plurality of code-division multiplexed channels, and said first control information includes channelization code information.

32. A method for wireless data transmission, comprising:
providing information produced by an intended recipient of a MIMIO data transmission; and
in response to said information, selecting one of a plurality of available antennas to transmit control information on a control channel used to provide parameters for the MIMO data transmission.

33. The method of claim 32, including selecting a modulation format for said control channel based on a number of antenna streams to be contained in the MIMO data transmission.

34. A method for wireless data transmission, comprising:
providing information indicative of a number of antenna streams to be contained in a MIMO data transmission; and
in response to said information, selecting a modulation format for transmission of control information on a control channel used to provide parameters for the MIMO data transmission.
